(19) United States
(12) Patent Application Publication
(10) Pub. No.: US 2016/0318792 A1
(43) Pub. Date: Nov. 3, 2016

(54) PRODUCTION METHOD OF OPTICAL FIBER PREFORM AND PRODUCTION METHOD OF OPTICAL FIBER

(71) Applicant: Furukawa Electric Co., Ltd., Tokyo (JP)

(72) Inventors: Ichihiko SUGANUMA, Tokyo (JP); Nobuaki ORITA, Tokyo (JP); Akihiro KANAO, Tokyo (JP)

(73) Assignee: Furukawa Electric Co., Ltd., Tokyo (JP)

(21) Appl. No.: 15/207,816

(22) Filed: Jul. 12, 2016

Related U.S. Application Data
(63) Continuation of application No. PCT/JP2015/050102, filed on Jan. 6, 2015.

(30) Foreign Application Priority Data
Jan. 16, 2014 (JP) 2014-006231

(51) Int. Cl. C03B 37/014; G02B 6/00; C03C 13/04

(52) U.S. Cl. CPC C03B 37/01446; C03B 37/014; C03B 37/0146; C03C 13/046; G02B 6/00; C03C 2213/00

(57) ABSTRACT

A production method of an optical fiber preform includes forming a porous preform by depositing a silica particle on a circumference of a target rod; and dehydrating and sintering the porous preform by at least three thermal treatment steps. A first and a second thermal treatment steps of the three thermal treatment steps dehydrate the porous preform in an atmosphere including halogen gas or halogen-based compound gas, and a processing temperature at the second thermal treatment step is higher than a processing temperature at the first thermal treatment step.

### CROSS-REFERENCE TO RELATED APPLICATION

This application is a continuation of PCT International Application No. PCT/JP2015/050102 filed on Jan. 6, 2015 which claims the benefit of priority from Japanese Patent Application No. 2014-006231 filed on Jan. 16, 2014, the entire contents of which are incorporated herein by reference.

### BACKGROUND

1. Field of the Invention

The present disclosure relates to a production method of an optical fiber preform and a production method of an optical fiber.

2. Description of the Related Art

In order to reduce production cost, an attempt of increasing optical fiber preforms in size is accelerated in recent years. Since an outer diameter of a porous preform for producing an optical fiber preform increases if a bulk density (or referred to as a soot density) is low, a heating furnace for heating the porous preform should be increased in size. Therefore, there is a need for increasing the bulk density of the porous preform (for example, see Japanese Laid-open Patent Publication No. 2007-106616).

Alternatively, as a technology for reducing production cost, there is a production method of an optical fiber preform using a sintering method in which a porous preform is sintered under a reduced pressure until it becomes a semi-transparent glass preform layer containing a closed cell and making the sintered semi-transparent glass preform layer be a transparent glass in an inert gas atmosphere other than a helium gas. According to this sintering method, there is a feature being capable of conducting a thermal treatment to a large-size optical fiber preform without using an expensive helium gas and within a short period of time, and thus, the sintering method contributes to reduction in production cost (for example, see Japanese Laid-open Patent Publication No. 2007-106616).

However, there is a problem that, when the bulk density of the porous preform is increased, in a well-known dehydration process, dehydration might not be conducted sufficiently, or the porous preform might not be doped with chlorine uniformly. When the dehydration process is insufficient, or when an amount of chlorine with which the porous preform is doped is not uniform, characteristics of a bare optical fiber of an optical fiber produced by drawing the optical fiber preform may be varied inevitably.

Particularly, when the dehydration process is insufficient, a loss at a wavelength of 1385 nm of an optical fiber being produced is affected to a large degree. Since the loss at the wavelength of 1385 nm is a feature defined by ITU-T (International Telecommunication Union) G.652D, it is very important to restrain this loss at a low degree for complying with the international standard.

There is a need for a production method of an optical fiber preform and a production method of an optical fiber of which characteristics vary to a fewer degree.

### SUMMARY

Our production method of an optical fiber preform includes: forming a porous preform by depositing a silica particle on a circumference of a target rod; and dehydrating and sintering the porous preform by at least three thermal treatment steps, a first and a second thermal treatment steps of the three thermal treatment steps dehydrate the porous preform in an atmosphere including halogen gas or halogen-based compound gas, and a processing temperature at the second thermal treatment step is higher than a processing temperature at the first thermal treatment step.

our production method of an optical fiber includes drawing an optical fiber preform produced by a production method of an optical fiber preform including: forming a porous preform by depositing a silica particle on a circumference of a target rod; and dehydrating and sintering the porous preform by at least three thermal treatment steps, a first and a second thermal treatment steps of the three thermal treatment steps dehydrate the porous preform in an atmosphere including halogen gas or halogen-based compound gas, and a processing temperature at the second thermal treatment step is higher than a processing temperature at the first thermal treatment step.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart illustrating orders of steps of a production method an optical fiber preform and steps of a production method of an optical fiber according to a first embodiment;

FIG. 2 is a schematic view illustrating a state of a porous preform in a porous-preform-forming step;

FIG. 3 is a view illustrating a schematic configuration of a soaking method type vitrification furnace being an example of a vitrification furnace used in a first dehydration step, a second dehydration step, and a sintering step;

FIG. 4 is a view illustrating a schematic configuration of a drawing device used in a drawing step; and

FIG. 5 is a flowchart illustrating orders of steps in a production method of an optical fiber preform and steps in a production method of an optical fiber according to a second embodiment.

### DETAILED DESCRIPTION

Hereafter, embodiments of a production method of an optical fiber preform and a production method of an optical fiber according to the present disclosure will be explained in detail with reference to the drawings. The present disclosure is not limited to the below-explained embodiments. Any terms not specifically defined in the description follow definitions and measuring methods of the ITU-T (International Telecommunication Union Standardization Sector) G. 650.1.

### First Embodiment

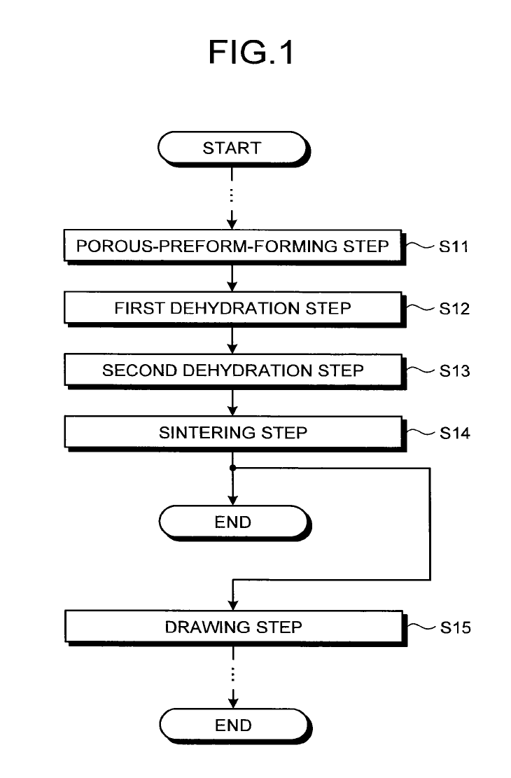

Herein, a production method of an optical fiber preform and a production method of an optical fiber according to a first embodiment will be explained with reference to FIGS. 1 to 4. FIG. 1 is a flowchart illustrating orders of steps of a production method an optical fiber preform and steps of a production method of an optical fiber according to the first embodiment. As illustrated in FIG. 1, the production method of the optical fiber preform according to the first embodiment has a porous-preform-forming step (step S11), a first dehydration step (step S12), a second dehydration step (step S13), and a sintering step (step S14). Moreover, the production method of the optical fiber according to the first embodiment has a drawing step (step S15) subsequent to the sintering step (step S14) of the production method of the optical fiber preform. Even when the production method includes a doping step or the like other than the above-described steps, the production method of the optical fiber preform and the production method of the optical fiber according to the present embodiment may be conducted appropriately.

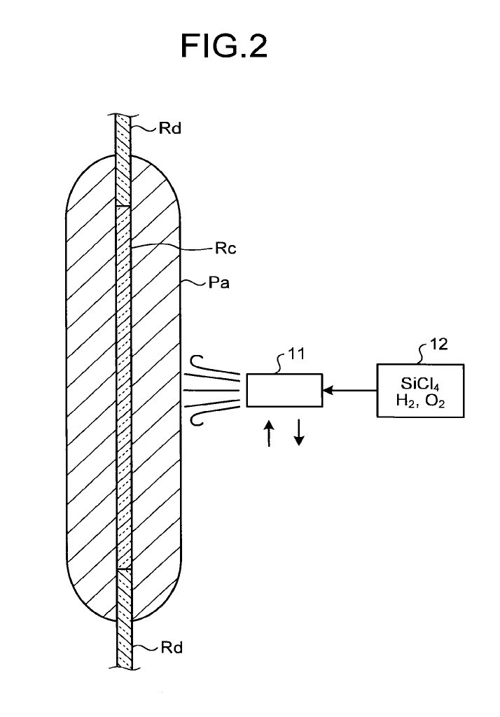

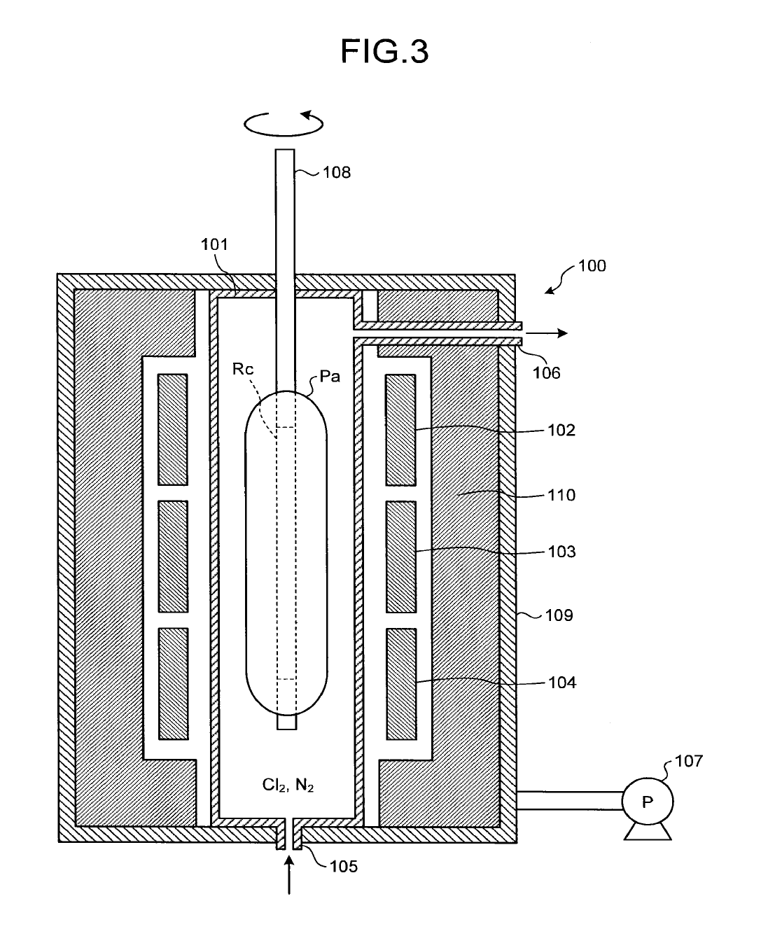

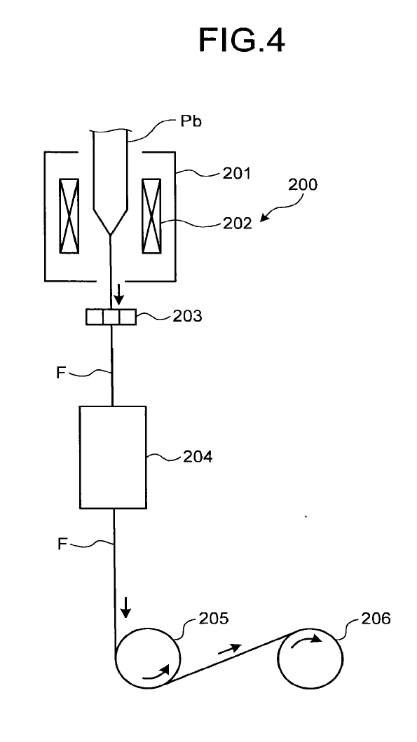

FIG. 2 is a schematic view illustrating a state of a porous preform in the porous-preform-forming step. FIG. 3 is a view illustrating a schematic configuration of a soaking method type vitrification furnace as an example of a vitrification furnace used in the first dehydration step, the second dehydration step, and the sintering step. FIG. 4 is a view illustrating a schematic configuration of a drawing device used in the drawing step. FIGS. 2 to 4 will be referred to in a later-described second embodiment as well.

In the production method of the optical fiber preform and the production method of the optical fiber according to the present embodiment, at first, in the porous-preform-forming step of the step S11, a silica-based glass particle is deposited on an outer periphery of a column-shaped core rod Rc made of silica-based glass and used as a target rod to form a porous preform Pa.

The core rod Rc that is produced, for example, by dehydrating and vitrifying a core soot produced by vapor phase axial deposition (VAD) method in a lowering method type vitrification furnace and extending the core soot to a predetermined diameter. The porous preform Pa is produced by depositing the silica-based glass particle on an outer periphery of the core rod Rc by outside vapor deposition (OVD) method. The core rod Rc includes a portion to be a core of an optical fiber and a portion to be a cladding formed around the core. In this case, in order to reduce the loss at the wavelength of 1385 nm sufficiently, it is preferable that an outer diameter ratio of the core and the cladding (cladding diameter/core diameter) of the core rod Rc be equal to or more than four times.

As illustrated in FIG. 2, two ends of the core rod Rc in the longitudinal direction are connected to a dummy rod Rd. The dummy rod Rd is used as a holder for holding, driving to rotate, and driving to lift up and down the porous preform Pa.

When depositing the silica-based glass particle by the OVD method, a gas 12 containing vaporized silicon tetrachloride (SiCl₄), oxygen (O₂) and hydrogen (H₂) is fed by a burner 11, and then, the gas 12 is ignited and combusted. The SiCl₄ subjected to a hydrolysis reaction in a flame becomes silica particles, and the silica particles are deposited on a circumference of the core rod Rc. The position of the burner 11 or the core rod Rc in the longitudinal direction is reciprocated repeatedly while rotating the core rod Rc, and the deposition is repeated until a porous layer reaches a sufficient thickness. When becoming an optical fiber later, the porous layer becomes a cladding portion being integrated with a cladding portion of the core rod Rc.

From a view point of increasing a size of the optical fiber preform, it is preferable that an average bulk density of the porous preform Pa be equal to or more than 0.6 g/cm³. On the other hand, in the dehydration step, since the dehydration is conducted more easily when the average bulk density is lower and since the dehydration becomes difficult exponentially along with an increase in density, it is preferable that the average bulk density be equal to or less than 1.0 g/cm³. Although the dehydration is easy when the average bulk density of the porous preform Pa is low, the dehydration is difficult when the average bulk density is equal to or more than 0.6 g/cm³. The present disclosure is particularly useful to the highly dense porous preform as such.

After that, the first and second dehydration steps and the sintering step of the steps S12 to S14 are conducted by using a vitrification furnace 100 illustrated in FIG. 3. Therefore, a configuration of the vitrification furnace 100 will be explained here.

The vitrification furnace 100 illustrated in FIG. 3 is a soaking method type vitrification furnace. As illustrated in FIG. 3, the vitrification furnace 100 includes a silica reactor core tube 101 that is a sealable vessel made of silica glass, and ring-shaped heaters 102, 103 and 104 that are heating elements provided around the silica reactor core tube 101. The silica reactor core tube 101 and the heaters 102, 103 and 104 are covered with a furnace body 109 entirely, and a heat insulation material 110 is filled between the furnace body 109 and the heaters 102, 103 and 104.

As illustrated in FIG. 3, the silica reactor core tube 101 has a volumetric capacity capable of enclosing the porous preform Pa thereinside and heats the porous preform Pa enclosed thereinside by the first heater 102, the second heater 103 and the third heater 104. The first heater 102, the second heater 103 and the third heater 104 are arranged along the longitudinal direction of the porous preform Pa when the porous preform Pa is enclosed inside the silica reactor core tube 101, and the first heater 102, the second heater 103 and the third heater 104 are arranged to heat an upper stage, a middle stage, and a lower stage of the porous preform Pa respectively. The porous preform Pa enclosed inside the silica reactor core tube 101 is rotated via a support bar 108 and heated homogeneously from the first heater 102, the second heater 103 and the third heater 104.

Moreover, a gas introduction port 105 and a gas-exhausting port 106 are provided to the silica reactor core tube 101 by which, for example, chlorine (Cl₂) and nitrogen (N₂) can be introduced to the inside of the silica reactor core tube 101. Gas being introduced to the inside of the silica reactor core tube 101 via the gas introduction port 105 is not limited to this kind, it is used to introduce silicon tetrafluoride (SiF₄) when doping the porous preform Pa with fluorine and is also used to introduce helium (He) when sintering the porous preform Pa. Moreover, a vacuum pump 107 connected to the silica reactor core tube 101 may decompress the inside of the silica reactor core tube 101.

In the first and second dehydration steps of the steps S12 and S13, the vitrification furnace 100 described as above is used to conduct dehydration of the porous preform Pa in an atmosphere of a mixture gas of chlorine and nitrogen. The atmospheric gas used in the first and second dehydration steps is not limited to the mixture gas of chlorine and nitrogen and may be one of three environments (conditions) such as under the reduced pressure, in an atmosphere of inert gas and halogen gas, and in an atmosphere of inert gas and halogen-based compound gas. For example, as a halogen, fluorine (F₂) may be used aside from chlorine, and thionyl chloride (SOCl₂) or the like may be used as a halogen-based compound.

In the first and second dehydration steps of the steps S12 and S13, the mixture gas of chlorine and nitrogen is introduced from the gas introduction port 105 provided to the silica reactor core tube 101. It is preferable that a partial pressure of chlorine in this state be 15% to 70%, and it is more preferable that the partial pressure be 25% to 50%. The partial pressure of chlorine may be changed between the first dehydration step and the second dehydration step. Although an atmospheric pressure in the silica reactor core tube 101 is a normal pressure basically, the inside of the silica reactor core tube 101 may be decompressed to a predetermined pressure by the vacuum pump 107 if necessary.

In the first dehydration step of the step S12 and in the second dehydration step of the step S13, the porous preform Pa is dehydrated by using the same vitrification furnace 100. That is, there is no change in the device itself between the first dehydration step of the step S12 and the second dehydration step of the step S13.

Processing temperatures for dehydration differs between the first dehydration step of the step S12 and the second dehydration step of the step S13. Therefore, outputs of the ring-shaped heaters 102, 103 and 104 provided around the silica reactor core tube 101 are adjusted respectively in the first dehydration step and the second dehydration step to be heated to appropriate furnace temperatures.

The first dehydration step is conducted at a temperature similar to a well-known dehydration step, and a specific processing temperature is 1000° C. to 1200° C. At the specific temperature, it is supposed that a contraction of the soot hardly occurs. It is because chlorine needs to be taken from a surface to an inside of the porous preform Pa in the first dehydration step, and if the porous preform Pa is contracted to a large degree, the originally high bulk density is supposed to inhibit intake of chlorine to a larger degree. For a processing time in the first dehydration step, it is preferable that, in order to conduct dehydration sufficiently, a time for heating the porous preform Pa to 1000° C. to 1200° C. be two or more hours. However, if the heating is conducted too long, since production takes longer time and thus production cost increases due to an increase or the like in an amount of gas being used, equal to or less than 4 hours is preferable. Hereafter, the processing time means a time period for heating the porous preform Pa to a predetermined temperature, and when conducting a process by a late-described zone-shift method, the processing time means a time period for heating respective portions to predetermined temperatures.

On the other hand, the second dehydration step is conducted at a temperature which is supposed to cause a certain degree of contraction, and a specific processing temperature is higher than 1200° C. and equal to or lower than 1300° C. A purpose of the second dehydration step is to make chlorine taken into the porous preform Pa at the first dehydration step be dispersed to thereinside. Moreover, there is an effect of restraining chlorine from being removed in the subsequent sintering step by increasing the density of the surface layer of the porous preform Pa. In this step, since the contraction of the porous preform Pa also progresses, if a step time is too long, the surface of the porous preform Pa becomes solidified, and thus degasification of hydrogen chloride and oxygen produced in a dehydration reaction does not progress. Therefore, attention should be paid to the step time. It is preferable that a processing time at the second dehydration step be one to two hours.

Subsequently, at the sintering step of the step S14, the porous preform Pa is sintered by using the vitrification furnace 100 similarly. That is, the used device itself does not change between the second dehydration step of the step S13 and the sintering step of the step S14, but outputs from the heaters 102, 103 and 104 and an atmospheric gas inside of the silica reactor core tube 101 are changed.

A sintering temperature at the sintering step of the step S14 is, for example, 1400° C. to 1600° C. and is adjusted appropriately in accordance with the porous preform Pa being used. In addition, in the sintering step, an inert gas of helium, nitrogen or the like is introduced from the gas introduction port 105. Using nitrogen but helium is preferable from a cost point of view. The inside of the silica reactor core tube 101 may be decompressed to a predetermined pressure by the vacuum pump 107 if necessary.

Although the first and second dehydration steps and the sintering step may be conducted by a vitrification furnace of a so-called lowering method in which the porous preform Pa is passed through a predetermined heating area from one end to the other of the porous preform Pa or by a zone-shift method in which temperatures of multi-staged heaters are adjusted to heat the porous preform Pa from one end to the other of the porous preform Pa, it is preferable that these steps be conducted by a soaking method type vitrification furnace heating the total length of the porous preform Pa simultaneously. It is because, since a highly dense soot is dehydrated, the soaking method type vitrification furnace heating the porous preform Pa entirely is capable of reducing a thermal processing time more than the other furnaces.

As illustrated in FIG. 1, in the production method of the optical fiber preform according to the present embodiment, the porous preform Pa is metamorphosed to the optical fiber preform at the sintering step of the step S14, and then the production step of the optical fiber preform is finished. On the other hand, in the production method of the optical fiber according to the present embodiment, the process progresses, subsequent to the sintering step of the step S14, to the drawing step of the step S15 for producing an optical fiber from the optical fiber preform.

FIG. 4 is a schematic view illustrating a schematic configuration of a drawing device used in the drawing step of the step S15. As illustrated in FIG. 4, a drawing device 200 includes, as main configurations, a drawing furnace 201, a resin application device 204, a guide roller 205, and a winding device 206.

The drawing furnace 201 includes a heater 202 thereinside, and an optical fiber F is drawn at the drawing step of the step S15 by fusing an end of an optical fiber preform Pb. An outer diameter of the optical fiber F drawn by the drawing furnace 201 is measured by an outer-diameter measurement unit 203 provided at a stage subsequent to the drawing furnace 201.

A resin coating is formed by the resin application device 204 on an outer periphery of the optical fiber F drawn by the drawing furnace 201. A resin application die and a UV irradiation device are provided inside the resin application device 204. The resin application die applies a resin on the outer periphery of the optical fiber F, and the UV irradiation device makes the applied resin be cured. The resin is applied to the outer periphery of the optical fiber F when being passed through the resin application die and the resin applied on the outer periphery of the optical fiber F is cured by the UV irradiation device.

The optical fiber F coated with the resin by the resin application device 204 is wound by the winding device 206 via the guide roller 205.

At the drawing step of the step S15, it is preferable that an inter-furnace temperature of the drawing furnace 201 be 2150° C. to 2200° C. A drawing speed (that is, a speed at which the winding device 206 winds the optical fiber F) is at least 1000 m/min., and for example, it is 2000 m/min.

As illustrated in FIG. 1, in the production method of the optical fiber according to the present disclosure, since the optical fiber is drawn from the optical fiber preform Pb at the drawing step of the step S15, the production step is finished.

As described above, the production method of the optical fiber preform and the production method of the optical fiber according to the first embodiment include the step of forming the porous preform Pa by depositing the silica particle on the outer periphery of the core rod Rc being used as a target rod, and the vitrification step for vitrifying the porous preform Pa by the thermal treatment step including at least the first dehydration step, the second dehydration step, and the sintering step. The first dehydration step and the second dehydration step conduct the thermal treatment to the porous preform Pa in the atmosphere of nitrogen and the halogen gas chlorine as inert gases, and the processing temperature at the second dehydration step is higher than the processing temperature at the first dehydration step. Hereby, the production method of the optical fiber preform and the production method of the optical fiber according to the first embodiment are capable of dehydrating the highly dense porous preform Pa sufficiently. The optical fiber produced from the sufficiently dehydrated porous preform Pa varies to a fewer degree in the loss at the wavelength of 1385 nm and other characteristics, and thus becomes a product being in good quality and satisfying ITU-T G.652D.

### Second Embodiment

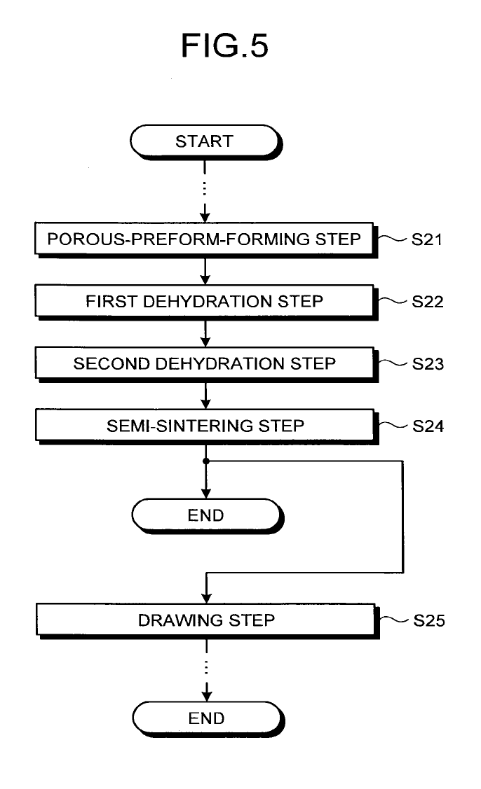

Hereafter, a production method of an optical fiber preform and a production method of an optical fiber according to the second embodiment will be explained with reference to FIG. 5. The production method of the optical fiber preform and the production method of the optical fiber in the second embodiment use devices that are similar to those of the first embodiment in configuration. Therefore, when explaining the second embodiment, explanation about configurations of devices will be omitted appropriately by referring to the configurations of the devices illustrated in FIGS. 2 and 3.

FIG. 5 is a flowchart illustrating orders of a production method of an optical fiber preform and a step of a production method of an optical fiber according to second embodiment. As illustrated in FIG. 5, the production method of the optical fiber preform according to the second embodiment includes the porous-preform-forming step (step S21), the first dehydration step (step S22), the second dehydration step (step S23), and a semi-sintering step (step S24). Moreover, the production method of the optical fiber according to the present embodiment includes the drawing step (step S25) subsequent to the semi-sintering step (step S24) of the production method of the optical fiber preform. That is, the semi-sintering step of the second embodiment is different from the sintering step of the first embodiment.

In the production method of the optical fiber preform and the production method of the optical fiber according to the present embodiment as well, at first, in the porous-preform-forming step of the step S21, the silica-based glass particle is deposited on the outer periphery of the column-shaped core rod Rc being made of silica-based glass and used as the target rod to form the porous preform Pa.

From the view point of increasing a size of the optical fiber preform, it is preferable that the average bulk density of the porous preform Pa be equal to or more than 0.6 g/cm³. On the other hand, in the dehydration step, since the dehydration is conducted more easily when the average bulk density is lower and since the dehydration becomes difficult exponentially along with an increase in density, it is preferable that the average bulk density be equal to or less than 1.0 g/cm³. Although the dehydration is easy when the average bulk density of the porous preform Pa is low, the dehydration is difficult when the average bulk density is equal to or more than 0.6 g/cm³. The present disclosure is particularly effective to the highly dense porous preform as such.

After that, the first and second dehydration steps and the sintering step being the steps S12 to S14 are conducted by using the vitrification furnace 100 exemplified in FIG. 1.

In the first and second dehydration steps of the steps S22 and S23, the vitrification furnace 100 described as above is used to conduct dehydration of the porous preform Pa in the atmosphere of the mixture gas of chlorine and nitrogen. The mixture gas of chlorine and nitrogen is introduced from the gas introduction port 105 provided to the silica reactor core tube 101. It is preferable that the partial pressure of chlorine in this state be 15% to 70%, and it is more preferable that the partial pressure be 25% to 50%. The partial pressure of chlorine may be changed between the first dehydration step and the second dehydration step. Although the atmospheric pressure in the silica reactor core tube 101 is the normal pressure basically, the atmospheric pressure inside the silica reactor core tube 101 can be decompressed to the predetermined pressure by the vacuum pump 107 if necessary.

The first dehydration step is conducted at the temperature similar to a well-known dehydration step, and the specific processing temperature is 1000° C. to 1200° C. At the specific temperature, it is supposed that a contraction of the soot hardly occurs. It is because chlorine needs to be taken from a surface to an inside of the porous preform Pa in the dehydration step, and if the porous preform Pa is contracted to a large degree, the originally high bulk density is supposed to inhibit intake of chlorine to a larger degree. For a processing time in the first dehydration step, in order to conduct dehydration sufficiently, two or more hours are preferable. However, if the heating is conducted too long, since production takes longer time and thus production cost increases due to an increase or the like in an amount of gas being used, equal to or shorter than 4 hours is preferable.

On the other hand, the second dehydration step is conducted at the temperature which is supposed to cause a certain degree of contraction, and a specific processing temperature is higher than 1200° C. and equal to or lower than 1300° C. A purpose of the second dehydration step is to make chlorine taken into the porous preform Pa at the first dehydration step be dispersed to thereinside in the vicinity of the core rod Rc. Also, the effect exists which restrains chlorine from being removed in a subsequent sintering step by increasing the density of the surface layer of the porous preform Pa. Particularly since chlorine tends to be removed when conducting a subsequent step under reduced pressure like the present embodiment, it is important to increase the density of the surface layer of the porous preform Pa in advance. In this step, since also the contraction of the porous preform Pa progresses, if the step time is too long, the surface of the porous preform Pa becomes solidified, and thus degasification of hydrogen chloride and oxygen produced in the dehydration reaction does not progress. Therefore, attention should be paid to the step time. It is preferable that the processing time at the second dehydration step be equal to or longer than one to two hours.

For parameters in the above-described first and second dehydration steps such as the inter-furnace temperature, the step time, the soot density, the chlorine gas concentration and the like, a combination of suitable parameters determined by an experiment will be used. The combination of these parameters will be proposed as Examples later.

Subsequently, in the semi-sintering step of the step S24, the porous preform Pa is semi-sintered by using the vitrification furnace 100 similarly. The “semi-sintering” here indicates not a normal sintering conducted to a “transparent glass state” but a sintering conducted to a “semi-transparent-glass state”.

The “semi-transparent-glass state” indicates a state containing a closed cell entirely and approximately uniformly and being apparently turbid and opaque. By contrast, the “transparent glass state” indicates a state not containing a closed cell entirely and approximately uniformly except a fine closed cell remaining in a part in a defective state and being apparently transparent. Herein the “closed cell” indicates a bubble or a space being formed inside a semi-transparent optical fiber preform and separated from an ambient atmosphere physically, and the inside of the “closed cell” is substantially vacuum.

An average density of the porous preform Pa in the “semi-transparent-glass state” is lower than a density (2.2 g/cm³) when becoming a perfect transparent glass finally. The average density in this “semi-transparent-glass state” is preferably equal to or more than 1.8 g/cm³, and is more preferably equal to or more than 2.0 g/cm³. The “closed cell” disappears easily in a drawing step S25, which will be explained later, by achieving the average density as such.

A sintering temperature at the semi-sintering step of the step S24 is adjusted appropriately in accordance with the porous preform Pa being used and is preferable at 1400° C. to 1550° C. It is preferable that a processing time of the semi-sintering step of the step S24 be, for example, three to five hours.

In the semi-sintering step of the step S24, the inside the silica reactor core tube 101 must be decompressed to a predetermined pressure by the vacuum pump 107. This is for the purpose of making inside of the above-described “closed cell” substantially vacuum. At the semi-sintering step of the step S24, the inside of the silica reactor core tube 101 needs to be decompressed to at least equal to or less than 2000 Pa, and preferably decompressed to equal to or less than 100 Pa. For an inert gas being an atmospheric gas in the semi-sintering step, using nitrogen is preferable from a cost point of view.

As illustrated in FIG. 5, in the production method of the optical fiber preform according to the present embodiment, the porous preform Pa is metamorphosed to the optical fiber preform in the semi-sintering step of the step S24, then the production step is finished. On the other hand, in the production method of the optical fiber according to the present embodiment, the process progresses, subsequent to the semi-sintering step of the step S24, to the drawing step for producing an optical fiber from the optical fiber preform.

The drawing step of the step S25 is conducted by using the drawing device 200 illustrated in FIG. 4. At the drawing step of the step S25, it is preferable that an inter-furnace temperature of the drawing furnace 201 be 2100° C. to 2150° C. A drawing speed (that is, a speed at which the winding device 206 winds the optical fiber F) is at least 1000 m/min., and for example, it is 2000 m/min.

At the drawing step of the step S25, the “closed cell” inside the optical fiber preform Pb disappears, and thus the optical fiber F in the “transparent glass state” is produced.

As illustrated in FIG. 5, in the production method of the optical fiber preform according to the present embodiment, since the optical fiber is drawn from the optical fiber preform Pb at the drawing step of the step S25, the production step is finished.

As described above, the production method of the optical fiber preform and the production method of the optical fiber according to the second embodiment include the step of forming the porous preform Pa by depositing the silica particle on the outer periphery of the core rod Rc being used as a target rod, and the vitrification step for vitrifying the porous preform Pa by the thermal treatment step including at least the first dehydration step, the second dehydration step, and the semi-sintering step. The first dehydration step and the second dehydration step conduct the thermal treatment to the porous preform Pa in the atmosphere of nitrogen and the halogen gas chlorine as inert gases, and the processing temperature at the second dehydration step is higher than the processing temperature at the first dehydration step. Hereby, the production method of the optical fiber preform and the production method of the optical fiber according to the second embodiment are capable of dehydrating the highly dense porous preform Pa sufficiently, and the highly dense porous preform Pa is in high degree of usefulness when being applied to the sintering method by the “semi-sintering”. Since the sintering method by the “semi-sintering” does not use expensive helium gas to a large-sized optical fiber preform, the production method of the optical fiber preform and the production method of the optical fiber according to the second embodiment contribute to reduction in production cost to a larger degree. Since using no helium gas not only enables reduction of cost for helium gas per se but also eliminates degasification of helium gas from the optical fiber preform, the steps may be simplified. Moreover, the optical fiber preform produced by the sintering method by the “semi-sintering” is an opaque member, a radiant energy may be absorbed in the drawing furnace effectively. Therefore, the production method of the optical fiber according to the second embodiment enables a decrease in the furnace temperature of the drawing furnace and thus the cost in this point as well may be reduced. That is, since the optical fiber produced from the sufficiently dehydrated porous preform Pa varies to a fewer degree in the loss at the wavelength of 1385 nm and other characteristics, and thus becomes a product being in good quality and satisfying ITU-T G.652D, the production method of the optical fiber according to the second embodiment enables production of an optical fiber being in good quality at a low cost.

Hereafter comparisons will be made among the optical fiber produced by the production method of the optical fiber according to the first embodiment, the optical fiber produced by the production method of the optical fiber according to the second embodiment, and an optical fiber produced by a known production method of an optical fiber. Examples 1 to 3 propose characteristics of the optical fibers produced by the production method of the optical fiber according to the second embodiment, an Example 4 proposes characteristics of the optical fiber produced by the production method of the optical fiber according to the first embodiment, and Comparative Examples 1 to 3 propose characteristics of the optical fiber produced by a commonly known production method of the optical fiber. Herein five optical fiber preforms were produced for each of the Examples 1 to 4 and the Comparative Examples 1 and 2, and characteristics of each optical fiber obtained from each optical fiber preform were measured at twenty points arranged with a uniform interval in a longitudinal direction.

### Example 1

A core rod Rc used in the porous-preform-forming step according to Example 1 was obtained by dehydrating and vitrifying a core produced by the VAD method in an ordinarily conducted lowering method of the vitrification furnace and by extending the dehydrated and vitrified core to a predetermined diameter. A cladding diameter/core diameter of the core rod Rc was 4.2, and a porous layer of which density was 0.7 g/cm³ was deposited by the OVD method on a circumference of the core rod Rc to produce the porous preform Pa.

At the first dehydration step, the second dehydration step and the semi-sintering step, the porous preform Pa was semi-sintered to the optical fiber preform Pb in the “semi-transparent-glass state” by using the vitrification furnace 100 as illustrated in FIG. 3. In this state, the processing temperature and the processing time at the first dehydration step are 1000° C. for 3 hours, and the processing temperature and the processing time at the second dehydration step are 1200° C. for 2 hours. An inter-furnace ambience at the first dehydration step and the second dehydration step is a mixture gas of chlorine and nitrogen under the normal pressure, and the chlorine partial pressure is 30%. The processing temperature and the processing time at the semi-sintering step were 1450° C. for 3 hours, and nitrogen gas decompressed to equal to or less than 100 Pa was used for the inter-furnace ambience. Herein the term of the normal pressure is used to mean a wide range of pressure neither being decompressed nor compressed specifically.

The average density of the optical fiber preform Pb being produced under the above-described condition and being in the “semi-transparent-glass state” was 2.1 g/cm³, and its surface was a smooth glass layer. Herein the average density being 2.1 g/cm³ corresponds to approximately 95% of an average density of 2.2 g/cm³ for a normal glass.

At the drawing step, the optical fiber F was drawn from the optical fiber preform Pb in the “semi-transparent-glass state” by using the drawing device 200 as illustrated in FIG. 4. The furnace temperature of the drawing furnace 201 in this state was 2100° C.

As a result of inspecting a bare optical fiber of the optical fiber F produced as explained above, a loss at the wavelength of 1385 nm was 0.278 to 0.284 dB/km, and its characteristics were stable relative to the longitudinal direction of the optical fiber F. This measurement result satisfies the ITU-T G.652D standard. Moreover, no problem was found in other characteristics such as cutoff wavelength, variation in fiber's outer diameter and the like of the bare optical fiber of the optical fiber F produced as explained above.

### Example 2

At the porous-preform-forming step according to Example 2, a core rod Rc produced by a method similar to that of the Example 1 was used to produce the porous preform Pa by depositing a porous layer of which density is 0.8 g/cm³ by the OVD method on a circumference of the core rod Rc.

At the first dehydration step, the second dehydration step and the semi-sintering step, the porous preform Pa was semi-sintered to the optical fiber preform Pb in the “semi-transparent-glass state” by using the vitrification furnace 100 as illustrated in FIG. 3. In this state, the processing temperature and the processing time at the first dehydration step are 1000° C. for 3 hours, and the processing temperature and the processing time at the second dehydration step are 1300° C. for an hour. The inter-furnace ambience at the first dehydration step and the second dehydration step is the mixture gas of chlorine and nitrogen under the normal pressure, and the chlorine partial pressure is similar to that of the Example 1. The processing temperature and the processing time at the semi-sintering step were 1450° C. for 3 hours, and the inter-furnace ambience was nitrogen gas decompressed to equal to or less than 100 Pa.

The average density of the optical fiber preform Pb being produced under the above-described condition and being in the “semi-transparent-glass state” was 2.1 g/cm³, and its surface was a smooth glass layer. Herein the average density being 2.1 g/cm³ corresponds to approximately 95% of an average density of 2.2 g/cm³ for a normal glass.

At the drawing step, the optical fiber F was drawn from the optical fiber preform Pb in the “semi-transparent-glass state” by using the drawing device 200 as illustrated in FIG. 4. The furnace temperature of the drawing furnace 201 in this state was 2100° C.

As a result of inspecting a bare optical fiber of the optical fiber F produced as explained above, a loss at the wavelength of 1385 nm was 0.280 to 0.286 dB/km and its characteristics were stable relative to the longitudinal direction of the optical fiber F. This measurement result satisfies the ITU-T G.652D standard. Moreover, no problem was found in other characteristics such as cutoff wavelength, variation in fiber diameter and the like of the bare optical fiber of the optical fiber F produced as explained above.

### Example 3

At the porous-preform-forming step according to Example 3, a core rod Rc produced by a method similar to that of the Example 1 was used to produce the porous preform Pa by depositing a porous layer of which density is 1.0 g/cm³ by the OVD method on a circumference of the core rod Rc.

At the first dehydration step, the second dehydration step and the semi-sintering step, the porous preform Pa was semi-sintered to the optical fiber preform Pb in the “semi-transparent-glass state” by using the vitrification furnace 100 as illustrated in FIG. 3. In this state, the processing temperature and the processing time at the first dehydration step are 1000° C. for 3 hours, and the processing temperature and the processing time at the second dehydration step are 1300° C. for 2 hours. The inter-furnace ambience at the first dehydration step and the second dehydration step is the mixture gas of chlorine and nitrogen under the normal pressure, and the chlorine partial pressure is similar to that of the Example 1. The processing temperature and the processing time at the semi-sintering step were 1450° C. for 3 hours, and the inter-furnace ambience was nitrogen gas decompressed to equal to or less than 100 Pa.

The average density of the optical fiber preform Pb being produced under the above-described condition and being in the “semi-transparent-glass state” was 2.1 g/cm³, and its surface was a smooth glass layer. Herein the average density being 2.1 g/cm³ corresponds to approximately 95% of an average density of 2.2 g/cm³ for a normal glass.

At the drawing step, the optical fiber F was drawn from the optical fiber preform Pb in the “semi-transparent-glass state” by using the drawing device 200 as illustrated in FIG. 4. The furnace temperature of the drawing furnace 201 in this state was 2100° C.

As a result of inspecting a bare optical fiber of the optical fiber F produced as explained above, a loss at the wavelength of 1385 nm was 0.282 to 0.289 dB/km and its characteristics were stable relative to the longitudinal direction of the optical fiber F. This measurement result satisfies the ITU-T G.652D standard. Moreover, no problem was found in other characteristics such as cutoff wavelength, variation in fiber's outer diameter and the like of the bare optical fiber of the optical fiber F produced as explained above.

### Example 4

At the porous-preform-forming step according to Example 4, a core rod Rc produced by a method similar to that of Example 1 was used to produce the porous preform Pa by depositing a porous layer of which density is 0.8 g/cm³ by the OVD method on a circumference of the core rod Rc.

At the first dehydration step, the second dehydration step and the semi-sintering step, the porous preform Pa was semi-sintered to the optical fiber preform Pb in the “semi-transparent-glass state” by using the vitrification furnace 100 as illustrated in FIG. 3. In this state, a processing temperature and a processing time at the first dehydration step are 1000° C. for 3 hours, and the processing temperature and the processing time at the second dehydration step are 1300° C. for an hour. The inter-furnace ambience at the first dehydration step and the second dehydration step is the mixture gas of chlorine and nitrogen under the normal pressure, and the chlorine partial pressure is similar to that of the Example 1. The processing temperature and the processing time at the sintering step were 1500° C. for 3 hours, and the inter-furnace ambience was nitrogen gas decompressed to equal to or less than 100 Pa.

At the drawing step, the optical fiber F was drawn from the optical fiber preform Pb in the “semi-transparent-glass state” by using the drawing device 200 as illustrated in FIG. 4. The furnace temperature of the drawing furnace 201 in this state was 2150° C.

As a result of inspecting a bare optical fiber of the optical fiber F produced as explained above, a loss at the wavelength of 1385 nm was 0.279 to 0.288 dB/km and its characteristics were stable relative to the longitudinal direction of the optical fiber F. This measurement result satisfies the ITU-T G.652D standard. Moreover, no problem was found in other characteristics such as cutoff wavelength, variation in fiber diameter and the like of the bare optical fiber of the optical fiber F produced as explained above.

### Comparative Example 1

At the porous-preform-forming step according to Comparative Example 1, a core rod Rc produced by a method similar to that of Examples 1 to 3 was used to produce the porous preform Pa by depositing a porous layer of which density is 0.8 g/cm³ by the OVD method on a circumference of the core rod Rc.

The vitrification step according to the Comparative Example 1 includes the dehydration step and the semi-sintering step, and unlike the Examples 1 to 3, a dehydration step according to the Comparative Example 1 is not separated into two stages. The processing temperature and the processing time at the sintering step according to the Comparative Example 1 were 1000° C. for 5 hours, and the inter-furnace ambience was the mixture gas of chlorine and nitrogen under the normal pressure, and the chlorine partial pressure is similar to that of Example 1.

The semi-sintering step according to the Comparative Example 1 is a step that is similar to that of the Examples 1 to 3. The processing temperature and the processing time are 1450° C. for 3 hours, and the inter-furnace ambience is nitrogen gas decompressed to equal to or less than 100 Pa.

The average density of the optical fiber preform Pb being produced under the above-described condition and being in the “semi-transparent-glass state” was 2.1 g/cm³, and its surface was a smooth glass layer. Herein the average density being 2.1 g/cm³ corresponds to approximately 95% of an average density of 2.2 g/cm³ for a normal glass.

At the drawing step, the optical fiber F was drawn from the optical fiber preform Pb in the “semi-transparent-glass state” by using the drawing device 200 as illustrated in FIG. 4. A furnace temperature of the drawing furnace 201 in this state was 2100° C.

As a result of inspecting a bare optical fiber of the optical fiber F produced as explained above, a loss at the wavelength of 1385 nm was 0.285 to 0.338 dB/km. This measurement result shows that the ITU-T G.652D standard is not satisfied in a part of the optical fibers. The bare optical fiber of the optical fiber F produced as described above varies to a large degree in cutoff wavelength and some of the bare optical fibers were irregular to the standard. As a result of this, it is estimated that the dehydration step of Comparative Example 1 is insufficient in dehydration effect, and a doping amount of chlorine is unequal.

### Comparative Example 2

At the porous-preform-forming step according to Comparative Example 2, a core rod Rc produced by a method similar to that of the Examples 1 to 3 was used to produce the porous preform Pa by depositing a porous layer of which density is 0.8 g/cm³ by the OVD method on a circumference of the core rod Rc.

The vitrification step according to the Comparative Example 2 includes the dehydration step and the semi-sintering step, and unlike the Examples 1 to 3, a dehydration step according to the Comparative Example 2 is not separated into two stages. The processing temperature and the processing time at the sintering step according to the Comparative Example 2 were 1200° C. for 5 hours, and the inter-furnace ambience was the mixture gas of chlorine and nitrogen under the normal pressure, and the chlorine partial pressure is similar to that of the Example 1.

The semi-sintering step according to the Comparative Example 2 is a step that is similar to that of the Examples 1 to 3. The processing temperature and the processing time are 1450° C. for 3 hours, and the inter-furnace ambience is nitrogen gas decompressed to equal to or less than 100 Pa.

The average density of the optical fiber preform Pb being produced under the above-described condition and being in the “semi-transparent-glass state” was 2.1 g/cm³, and its surface was a smooth glass layer. Herein the average density being 2.1 g/cm³ corresponds to approximately 95% of an average density of 2.2 g/cm³ for a normal glass.

At the drawing step, the optical fiber F was drawn from the optical fiber preform Pb in the “semi-transparent-glass state” by using the drawing device 200 as illustrated in FIG. 4. The furnace temperature of the drawing furnace 201 in this state was 2200° C., and the drawing could not be conducted unless the furnace temperature was increased. As a result of this, it is estimated that, at the dehydration step of the Comparative Example 2, the doping with chlorine was not sufficient.

As a result of inspecting a bare optical fiber of the optical fiber F produced as explained above, a loss at the wavelength of 1385 nm was 0.293 to 0.395 dB/km. This measurement result does not satisfy the ITU-T G.652D standard. The bare optical fiber of the optical fiber F produced as described above varies to a large degree in cutoff wavelength and some of the bare optical fibers were irregular to the standard. As a result of this, it is estimated that the dehydration step of the Comparative Example 2 as well is insufficient in dehydration effect, and a doping amount of chlorine is unequal.

### Comparative Example 3

At the porous-preform-forming step according to Comparative Example 3, a core rod Rc produced by a method similar to that of the Examples 1 to 3 was used to produce the porous preform Pa by depositing a porous layer of which density is 0.8 g/cm³ by the OVD method on a circumference of the core rod Rc.

The vitrification step according to the Comparative Example 3 includes the dehydration step and the semi-sintering step, and unlike the Examples 1 to 3, a dehydration step according to the Comparative Example 3 is not separated into two stages. The processing temperature and the processing time at the sintering step according to the Comparative Example 3 were 1300° C. for 3 hours, and the inter-furnace ambience was the mixture gas of chlorine and nitrogen under the normal pressure, and the chlorine partial pressure is similar to that of the Example 1.

The semi-sintering step according to the Comparative Example 3 is a step that is similar to that of the Examples 1 to 3. The processing temperature and the processing time are 1450° C. for 3 hours, and the inter-furnace ambience is nitrogen gas decompressed to equal to or less than 100 Pa.

The average density of the optical fiber preform Pb being produced under the above-described condition and being in the “semi-transparent-glass state” was 2.1 g/cm³, and its surface was a smooth glass layer. Herein the average density being 2.1 g/cm³ corresponds to approximately 95% of an average density of 2.2 g/cm³ for a normal glass.

At the drawing step, the optical fiber F was drawn from the optical fiber preform Pb in the “semi-transparent-glass state” by using the drawing device 200 as illustrated in FIG. 4. However, in the optical fiber preform Pb according to the Comparative Example 3, a fluctuation occurred in an outer diameter of the optical fiber F, and thus, a normal drawing could not be conducted.

When making sure of the optical fiber preform and the optical fiber for which drawing steps were stopped, it was acknowledged that a bubble being other than the previously-explained closed cell was produced in the optical fiber preform, and a bubble remained in the optical fiber as well. This is estimated that since a temperature at the dehydration was so increased that the sintering progressed at the dehydration step to a large degree.

As described above, although, in any one of the Examples 1 to 3, the loss at the wavelength of 1385 nm was equal to or less than 0.31 dB/km being the ITU-T G.652D standard and fluctuation in the longitudinal direction of the optical fiber produced by the same porous preform was equal to or less than 0.01 dB/km, the loss at the wavelength of 1385 nm was equal to or more than 0.31 dB/km in some cases of Comparative Examples 1 and 2, and fluctuation in the optical fiber produced from the same porous preform is great, which is equal to or more than 0.05 dB/km. An average value of a loss at the wavelength of 1385 nm of the Example 1 was 0.279 dB/km and a standard deviation σ was 0.0012 dB/km. An average value of a loss at the wavelength of 1385 nm of the Comparative Example 1 was 0.294 dB/km and a standard deviation σ was 0.0131 dB/km. Moreover, a standard deviation σ of a cutoff wavelength in the Example 1 was 11.9 nm, and a standard deviation σ of a cutoff wavelength in the Comparative Example 1 was 33.5 nm.

Although the present disclosure was explained in accordance with the above-described Embodiments, the present disclosure is not limited to the description and drawings constituting a part of disclosure of the present disclosure in accordance with the present Embodiments. That is, all of other Embodiments, Examples, operational technologies and the like made by an ordinary skilled person in the art based on the present Embodiments are included within the scope of the present disclosure.

For example, although a target rod is the core rod Rc including the core in the description above, the target rod may be a glass rod or a mandrel made of silica-based glass not continuing the core. The target rod may be extracted to be a cylindrical porous preform subsequent to the porous-preform-forming step of the step S11, and the first and second dehydration steps and the sintering step of the steps S12 to S14 may be conducted to this cylindrical porous preform. In this case, at the porous-preform-forming step of the step S11, the optical fiber preform is formed by a method forming a portion becoming the core and a portion becoming the cladding when the optical fiber is produced, or by a method of maintaining a hole in a center portion and inserting the core rod Rc into the hole to make the hole and the core rod Rc be subjected to the fusion and the integration together in the steps S12 to S14. The fusion and the integration may be conducted simultaneously with the drawing, and another step therefor may be provided.

As described above, the production method of the optical fiber preform and the production method of the optical fiber according to the present disclosure are useful for use in production of the optical fiber preform and the optical fiber of which variations in characteristics are very few.

According to the production method of the optical fiber preform and the production method of the optical fiber according to the present disclosure, an effect of achieving sufficient dehydration of a porous preform having high bulk density may be obtained.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A production method of an optical fiber preform, comprising:
forming a porous preform by depositing a silica particle on a circumference of a target rod; and
dehydrating and sintering the porous preform by at least three thermal treatment steps, wherein
a first and a second thermal treatment steps of the three thermal treatment steps dehydrate the porous preform in an atmosphere including halogen gas or halogen-based compound gas, and
a processing temperature at the second thermal treatment step is higher than a processing temperature at the first thermal treatment step.

2. The production method of the optical fiber preform according to claim 1, wherein
the processing temperature at the first thermal treatment step is equal to or less than 1200° C., and
the processing temperature at the second thermal treatment step is higher than 1200° C.

3. The production method of the optical fiber preform according to claim 1, wherein
a processing time at the first thermal treatment step is 2 to 4 hours, and
a processing time at the second thermal treatment step is 1 to 2 hours.

4. The production method of the optical fiber preform according to claim 1, wherein the atmosphere is a mixture gas of chlorine and nitrogen.

5. The production method of the optical fiber preform according to claim 1, wherein the first thermal treatment step and the second thermal treatment step are conducted under a normal pressure.

6. The production method of the optical fiber preform according to claim 1, wherein the porous preform is sintered under a reduced pressure and at a processing temperature between 1400° C. to 1550° C. at a third thermal treatment step of the three thermal treatment steps.

7. A production method of an optical fiber, comprising:
drawing an optical fiber preform produced by a production method including:
forming a porous preform by depositing a silica particle on a circumference of a target rod; and
dehydrating and sintering the porous preform by at least three thermal treatment steps, wherein
a first and a second thermal treatment steps of the three thermal treatment steps dehydrate the porous preform in an atmosphere including halogen gas or halogen-based compound gas, and
a processing temperature at the second thermal treatment step is higher than a processing temperature at the first thermal treatment step.

8. The production method of the optical fiber according to claim 7, wherein
the processing temperature at the first thermal treatment step is equal to or less than 1200° C., and
the processing temperature at the second thermal treatment step is higher than 1200° C.

9. The production method of the optical fiber according to claim 7, wherein
a processing time at the first thermal treatment step is 2 to 4 hours, and
a processing time at the second thermal treatment step is 1 to 2 hours.

10. The production method of the optical fiber according to claim 7, wherein the atmosphere is a mixture gas of chlorine and nitrogen.

11. The production method of the optical fiber according to claim 7, wherein the first thermal treatment step and the second thermal treatment step are conducted under a normal pressure.

12. The production method of the optical fiber according to claim 7, wherein the porous preform is sintered under a reduced pressure and at a processing temperature between 1400° C. to 1550° C. at a third thermal treatment step of the three thermal treatment steps.
